(19) United States
(12) Patent Application Publication
(10) Pub. No.: US 2025/0230307 A1
(43) Pub. Date: Jul. 17, 2025

(54) MULTILAYERED FILM

(71) Applicant: BOREALIS AG, Vienna (AT)

(72) Inventors: Jingbo WANG, Linz (AT); Friedrich BERGER, Linz (AT); Arnaud ALABRUNE, Courbevoie (FR); Chantal SEMAAN, Barcelona (ES); Anthony BERTHELIER, Courbevoie (FR)

(73) Assignee: BOREALIS AG, Vienna (AT)

(21) Appl. No.: 18/853,796

(22) PCT Filed: Apr. 4, 2023
(86) PCT No.: PCT/EP2023/058738

§ 371 Date: Oct. 3, 2024

(30) Foreign Application Priority Data
Apr. 6, 2022 (EP) 22166941.9

(51) Int. Cl. C08L 23/0807; B32B 27/08; B32B 27/32

(52) U.S. Cl. CPC C08L 23/0815; B32B 27/08; B32B 27/327; B32B 2250/242; B32B 2270/00; B32B 2307/30; B32B 2307/31; B32B 2307/412; B32B 2307/54; B32B 2307/558; B32B 2307/704; B32B 2307/72; B32B 2307/7376; B32B 2439/70; B32B 2439/80; C08L 2203/162; C08L 2205/025; C08L 2205/035; C08L 2207/062; C08L 2207/066; C08L 2314/06

(57) ABSTRACT

The present disclosure relates to a multilayered film including a skin layer, a core layer and a sealing layer; wherein at least the core layer includes a specific metallocene-catalysed multimodal polyethylene copolymer. The present disclosure furthermore relates to the use of the multilayered film as packaging material.

The present invention relates to a multilayered film comprising a skin layer (SKL), a core layer (CL) and a sealing layer (SL), wherein at least one of said layers comprises a specific metallocene-catalysed multimodal polyethylene copolymer (MMCP). The present invention furthermore relates to the use of said multilayered film as packaging material.

Polyethylenes are widely used everywhere in daily life, like packaging, due to their excellent cost/performance ratios. Due to the different requirements nowadays multilayered films with different type of materials are used, which from one side serve the needs, but have the disadvantage that recycling of these films is difficult. From a recycling point of view, mono-material solutions would be preferred. Furthermore, there is need for multilayer films which tolerate the presence of recycled polymer and at the same time show an acceptable performance.

Mono-material solutions and multilayer films containing recycled polymers are already known in the prior art.

WO 2021/259910 A1 relates to a tubular film intended to form a stretch hood. The tubular film has a core layer and at least one skin layer. The core layer comprises, by weight of the core layer: 30 to 80% of recycled polyethylene, 10 to 35% of a polymer booster selected from a thermoplastic elastomer and a polyolefin plastomer, and 0 to 40% of virgin ethylene polymer and/or virgin ethylene based copolymer.

WO 2021/173771 A1 refers to a multilayer film, a packaging article and a method of manufacture a packaging article from the multilayer film. The multilayer film having at least 25% scrap material content, a compatibilizer and antioxidant and being useful for the packaging of food products. The scrap material including a blend of polymers reclaimed from streams of waste and recycling.

EP 3 838 587 A1 relates to a multilayer stretch wrap film, particularly a polyolefin stretch film comprising at least 20 wt.-% of PCR plastic waste material, a method of preparation thereof and the use of the multilayer stretch film according to the invention for stretch wrapping operations of goods.

WO 2021/074697 A1 refers to a shrink film which may include at least one layer comprising a blended ethylene-based polymer composition, the blended ethylene-based polymer composition having a PCR content varying from greater than 5 to less than 95 wt.-% and a virgin resin content varying from greater than 5 to less than 95 wt.-%, wherein the virgin resin is selected from HDPE, LLDPE, LDPE, or combinations thereof.

Starting therefrom, it is one objective of the present invention to provide a multilayered film which is not only easy to recycle but has also a good balance of mechanical and optical properties, has excellent sealing properties and tolerates the presence of already recycled polymers.

These objective has been solved by the multilayered film according to claim 1 comprising a skin layer (SKL), a core layer (CL) and a sealing layer (SL); wherein at least the core layer comprises a metallocene-catalysed multimodal polyethylene copolymer (MMCP), which comprises
(i) 35.0 to 50.0 wt.-% based on the total weight of MMCP of an ethylene-1-butene polymer component (A); and
(ii) 50.0 to 65.0 wt.-% based on the total weight of MMCP of an ethylene-1-hexene polymer component (B); wherein
the ethylene-1-butene polymer component (A) has
   a density (ASTM D792) in the range of 920 to 960 kg/m³;
   a MFR₂ (190° C., 2.16 kg, ISO 1133) in the range of 3.0 to 300.0 g/10 min;
   a 1-butene content in the range of 0.1 to 3.0 mol-%, based on the ethylene-1-butene polymer component (A); and
the ethylene-1-hexene polymer component (B) has
   a density (ASTM D792) in the range of 880 to 920 kg/m³;
   an MFR₂ (190° C., 2.16 kg, ISO 1133) in the range of 0.001 to 1.0 g/10 min;
   a 1-hexene content in the range of 1.5 to 10.0 mol-% based on the ethylene-1-hexene polymer compound (B); and
the metallocene-catalysed multimodal polyethylene copolymer (MMCP) has
   a density (ASTM D792) in the range of 910 to 930 kg/m³;
   a MFR₂ (190° C., 2.16 kg, ISO 1133) in the range of 0.1 to 1.4 g/10 min; and
   a ratio of the MFR₂₁ (190° C., 21.6 kg, ISO 1133) to MFR₂ (190° C., 2.16 kg, ISO 1133), MFR₂₁/MFR₂, in the range of 22 to 70;
whereby the core layer further comprises
a mixed-plastic-polyethylene recycling blend having a MFR₂ (190° C., 2.16 kg, ISO 1133) in the range of 0.1 to 1.2 g/10 min and a density (ASTM D792) of 910 to 945 kg/m³.

Advantageous embodiments of the multilayered film in accordance with the present invention are specified in the dependent claims 2 to 14. The present invention further relates in accordance with claim 15 to the use of the multilayer film according to the present invention as packaging material.

### Definitions

A metallocene-catalysed (linear low density) polyethylene is defined in this invention as a (linear low density) polyethylene copolymer, which has been produced in the presence of a metallocene catalyst.

A Ziegler-Natta-catalysed (linear low density) polyethylene is defined in this invention as a (linear low density) polyethylene copolymer, which has been produced in the presence of a Ziegler-Natta catalyst.

For the purpose of the present invention the metallocene-catalysed (linear low density) polyethylene consisting of an ethylene-1-butene polymer component (A) and an ethylene-1-hexene polymer component (B) means that the polymer is produced in an at least 2-stage sequential polymerization process, wherein first component (A) is produced and component (B) is then produced in the presence of component (A) in a subsequent polymerization step, yielding the metallocene-catalysed (linear low density) polyethylene or vice versa, i.e. first component (B) is produced and component (A) is then produced in the presence of component (B) in a subsequent polymerization step, yielding the metallocene-catalysed (linear low density) polyethylene.

The term “multimodal” in context of multimodal metallocene-catalysed (linear low density) polyethylene means herein multimodality with respect to melt flow rate (MFR) of at least the ethylene polymer components (A) and (B), i.e. the ethylene polymer components (A) and (B), have different MFR values. The multimodal metallocene-catalysed (linear low density) polyethylene can have further multimodality between the ethylene polymer components (A) and (B) with respect to one or more further properties, like density, comonomer type and/or comonomer content, as will be described later below.

For the purposes of the present description and of the subsequent claims, the term “recycled LDPE” is used to indicate that the material is recovered from post-consumer waste and/or industrial waste. Namely, post-consumer waste refers to objects having completed at least a first use cycle (or life cycle), i.e. having already served their first purpose; while industrial waste refers to the manufacturing scrap which does normally not reach a consumer. In the gist of the present invention “recycled LDPE” may also comprise up to 20 wt.-%, preferably up to 15 wt.-%, more preferably up to 10 wt.-% and even more preferably up to 5 wt.-% based on the overall weight of the recycled LDPE of other components like for example LLDPE, MDPE, HDPE. Respectively, the term “virgin” denotes the newly produced materials and/or objects prior to first use and not being recycled. In case that the origin of the polymer is not explicitly mentioned the polymer is a “virgin” polymer.

Low density polyethylene (LDPE) is defined in this invention as low density polyethylene copolymer, which has been preferably produced in a high-pressure process.

An ethylene homopolymer is a polymer that essentially consists of ethylene monomer units. Due to impurities especially during commercial polymerization processes, an ethylene homopolymer can comprise up to 1.0 mol-% comonomer units, preferably up to 0.5 mol-% comonomer units and most preferably up to 0.01 mol-% comonomer units.

A mono-material film in the context of the present invention may be a film using mainly one kind of polymer for example polyethylene, but no other polymers in significant amounts. However, in case the film is polyethylene-based different polyethylenes may be present.

Where the term “comprising” is used in the present description and claims, it does not exclude other non-specified elements of major or minor functional importance. For the purposes of the present invention, the term “consisting of” is considered to be a preferred embodiment of the term “comprising of.” If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### Metallocene-Catalysed Multimodal Polyethylene Copolymer (MMCP)

At least the core layer of the multilayered film according to the present invention comprises a specific metallocene-catalysed multimodal polyethylene copolymer (MMCP).

Said specific copolymer (MMCP) comprises and preferably consists of (i) 35.0 to 50.0 wt.-% based on the total weight of MMCP of an ethylene-1-butene polymer component (A) and (ii) 50.0 to 65.0 wt.-% based on the total weight of MMCP of an ethylene-1-hexene polymer component (B).

The ethylene-1-butene polymer component (A) has a density (ASTM D792) in the range of 920 to 960 kg/m³, a MFR₂ (190° C., 2.16 kg, ISO 1133) in the range of 3.0 to 300.0 g/10 min, a 1-butene content in the range of 0.1 to 3.0 mol-%, based on the ethylene-1-butene polymer component (A).

The ethylene-1-hexene polymer component (B) has a density (ASTM D792) in the range of 880 to 920 kg/m³, a MFR₂ (190° C., 2.16 kg, ISO 1133) in the range of 0.001 to 1.0 g/10 min; a 1-hexene content in the range of 1.5 to 10.0 mol-% based on the ethylene-1-hexene polymer compound (B).

The metallocene-catalysed multimodal polyethylene copolymer (MMCP) has a density (ASTM D792) in the range of 910 to 930 kg/m³, a MFR₂ (190° C., 2.16 kg, ISO 1133) in the range of 0.1 to 1.4 g/10 min; and a ratio of the MFR₂₁ (190° C., 21.6 kg, ISO 1133) to MFR₂ (190° C., 2.16 kg, ISO 1133), MFR₂₁/MFR₂, in the range of 22 to 70.

In a preferred embodiment of the present invention, the ethylene-1-butene polymer component (A) consists of an ethylene polymer fraction (A-1) and (A-2).

In case that the ethylene-1-butene polymer component (A) consists of ethylene polymer fractions (A-1) and (A-2), the MFR₂ of the ethylene polymer fractions (A-1) and (A-2) may be the same different from each other.

The ethylene polymer fractions (A-1) and/or (A-2) may have an MFR₂ (190° C., 2.16 kg, ISO 1133) in the range of 3.0 to 300.0 g/10 min, preferably of 3.0 to 10.0 g/10 min or 80 to 150.0 g/10 min, more preferably of 4.0 to 7.0 g/10 min or 6.0 to 8.0 g/10 min or 115 to 125 g/10 min.

In a preferred embodiment The MFR₂ of the ethylene polymer components (A) and (B) are different from each other.

The ethylene polymer component (A) preferably has an MFR₂ (190° C., 2.16 kg, ISO 1133) in the range of 3.0 to 200 g/10 min, more preferably of 3.5 to 11 g/10 min or 100 to 130 g/10 min, still more preferably of 4.0 to 9.0 g/10 min or 115 to 128 g/10 min and even more preferably of 4.5 to 8.5 g/10 min or 120 to 125 g/10 min.

The ethylene polymer component (B) has an MFR₂ (190° C., 2.16 kg, ISO 1133) in the range of 0.001 to 1.0 g/10 min, preferably of 0.005 to 0.8 g/10 min, more preferably of 0.2 to 0.6 g/10 min and even more preferably of 0.01 to 0.5 g/10 min.

The MFR₂ (190° C., 2.16 kg, ISO 1133) of the multimodal copolymer (MMCP) preferably is in the range of 0.1 to 1.35 g/10 min, more preferably 0.4 to 1.30 g/10 min or 0.5 to 0.7 g/10 min.

Naturally, in addition to multimodality with respect to, i.e. difference between, the MFR₂ of ethylene polymer components (A) and (B), the multimodal PE of the invention can also be multimodal e.g. with respect to one or both of the two further properties: multimodality with respect to, i.e. difference between, the comonomer content(s) present in the ethylene polymer components (A) and (B); and/or the density of the ethylene polymer components (A) and (B).

Preferably, the multimodal copolymer (MMCP) is further multimodal with respect to the comonomer content of the ethylene polymer components (A) and (B).

The comonomer type for the polymer fractions (A-1) and (A-2) is the same, thus both fractions therefore have 1-butene as comonomer.

The comonomer content of component (A) and (B) can be measured, or, in case, and preferably, one of the components is produced first and the other thereafter in the presence of the first produced in a so called multistage process, then the comonomer content of the first produced component, e.g. component (A), can be measured and the comonomer content of the other component, e.g. component (B), can be calculated according to following equation:

$$Comonomer content ( mol - \% or wt . - \% ) in component B = ( comonomer content ( mol - \% or wt . - \% ) in final product - ( weight fraction of component A * comonomer content ( mol - \% or wt . - \% ) in component A ) ) / ( weight fraction of component B ) .$$

The multimodal copolymer (MMCP) has a ratio of the MFR₂₁ (190° C., 21.6 kg, ISO 1133) to MFR₂ (190° C., 2.16 kg, ISO 1133), MFR₂₁/MFR₂, in the range of from 22 to 70, preferably from 22 to 50, more preferably from 23 to 50 and still more preferably from 28 to 46.

According to one preferred embodiment of the present invention the content of the ethylene-1-butene polymer component (A) is in the range of 35 to 50 wt.-% based on the total weight of MMCP, preferably of 36 to 48 wt.-% and more preferably of 38 to 45 wt.-% and/or the content of the ethylene-1-hexene polymer component (B) based on the total weight of MMCP is in the range of 50 to 65 wt.-% based on the total weight of MMCP, preferably of 52 to 64 wt.-% and more preferably of 55 to 62 wt.-%.

The total amount of 1-butene, based on the multimodal polymer (MMCP) is preferably in the range of from 0.1 to 1.0 mol-%, more preferably 0.2 to 0.8 mol-% and even more preferably 0.3 to 0.7 mol-%.

The total amount of 1-hexene, based on the multimodal polymer (MMCP) preferably is in the range of 1.5 to 8.0 mol-%, more preferably 2.0 to 6.0 mol-% and even more preferably 2.2 to 4.0 mol-%.

The total amount of 1-butene, present in the ethylene-1-butene polymer component (A) is of 0.1 to 3.0 mol-%, preferably of 0.3 to 2.6 mol-%, more preferably of 0.5 to 2.0 mol-%, even more preferably of 0.6 to 1.8 mol-%, based on the ethylene-1-butene polymer component (A).

The total amount (mol-%) of 1-hexene, present in the ethylene-1-hexene polymer component (B) is of 1.5 to 10.0 mol-%, preferably of 3.0 to 8.0 mol-%, more preferably of 3.5 to 7.0 mol-%, based on the ethylene-1-hexene polymer component (B).

Even more preferably the multimodal polymer (MMCP) of the invention is further multimodal with respect to difference in density between the ethylene polymer component (A) and ethylene polymer component (B). Preferably, the density of ethylene polymer component (A) is different, preferably higher, than the density of the ethylene polymer component (B).

The density of the ethylene polymer component (A) is in the range of 920 to 960 kg/m³, preferably of 925 to 955 kg/m³, more preferably 930 to 950 kg/m³ and/or the density of the ethylene polymer component (B) is of in the range of 880 to 920 kg/m³, preferably of 885 to 915 kg/m³ and more preferably of 890 to 910 kg/m³.

The polymer fractions (A-1) and/or (A-2) may have a density in the range of from 925 to 960 kg/m³, preferably of 925 to 955 kg/m³, more preferably of 930 to 950 kg/m³.

The density of polymer fraction (A-1) and (A-2) may be the same or may be different from each other.

The metallocene catalysed multimodal copolymer (MMCP) is preferably a linear low density polyethylene (LLDPE) which has a well known meaning.

The density of the multimodal copolymer (MMCP) is in the range of 910 to 930 kg/m³, preferably of 912.0 to 925 kg/m³ and more preferably of 913.0 to 918.0 kg/m³.

More preferably the multimodal copolymer (MMCP) is multimodal at least with respect to, i.e. has a difference between, the MFR₂, the comonomer content as well as with respect to, i.e. has a difference between the density of the ethylene polymer components, (A) and (B), as defined above, below or in the claims including any of the preferable ranges or embodiments of the polymer composition.

The multimodal copolymer (MMCP) furthermore may have a molecular weight distribution (Mw/Mn) determined with GPC in the range of at least 3.5 up to 7.2, preferably in the range of 4.0 to 7.0 and more preferably in the range of 4.5 to 6.8.

Furthermore the multimodal copolymer (MMCP) has a ratio of the soluble fraction at 35° C. determined with crossfractionation chromatography (CFC) as described in the experimental part to the density of the multimodal polyethylene copolymer (MMCP), SF@35° C./density_{MMCP} of below 0.007, preferably below 0.006, more preferably below 0.005, like in the range of 0.001 to below 0.007, preferably 0.001 to below 0.006 and more preferably 0.001 to below 0.005 or below 0.050.

The amount of the soluble fraction at 35° C., based on the total multimodal polyethylene copolymer (MMCP) is in the range of 0.5 to 6.0 wt.-%, preferably 0.8 to 5.0 wt.-%, more preferably 1.0 to 4.0 wt.-% or of 39 to 43 wt.-%.

In an embodiment of the present invention the multimodal polyethylene copolymer (MMCP) is additionally characterized by a ratio of the molecular weight (Mw) of the low crystalline fraction (LCF) to the molecular weight (Mw) of the high crystalline fraction (HCF), Mw(Tp(LCF)/Mw(Tp(HCF), determined as described in the experimental part, in the range of from >1.0 to 10.0, preferably in the range of 2.0 to 8.0, and more preferably of 2.2 to 6.0 and/or
a ratio of the breadth at Half peak height (LCF)/(98−Tp(LCF)) in the range of from 0.10 to 1.50, preferably in the range of 0.15 to 1.2 and more preferably in the range of 0.20 to 1.0 and/or
a delta of Mw(LCF)−Mw(HCF) of at least 5000 up to 200000 g/mol, preferably 50000 to 180000 g/mol, more preferably 80000 to 150000 g/mol or 5000 to 7000 g/mol.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 35.0 to 50.0 wt.-% based on the multimodal copolymer (MMCP), preferably in an amount of 36.0 to 48.0 wt.-% and even more preferably in an amount of 38.0 to 45.0 wt.-%.

Thus, the ethylene polymer component (B) is present in an amount of 50.0 to 65.0 wt.-% based on the multimodal copolymer (MMCP), preferably in an amount of 52.0 to 64.0 wt.-% and more preferably in an amount of 55.0 to 62.0 wt.-%.

The metallocene-catalysed multimodal copolymer (MMCP), can be produced in a 2-stage process, preferably comprising a slurry reactor (loop reactor), whereby the slurry (loop) reactor is connected in series to a gas phase reactor (GPR), whereby the ethylene polymer component (A) is produced in the loop reactor and the ethylene polymer component (B) is produced in GPR in the presence of the ethylene polymer component (A) to produce the multimodal copolymer (MMCP).

In case that the ethylene component (A) of the multimodal copolymer (MMCP) consists of ethylene polymer fractions (A-1) and (A-2), the multimodal copolymer (MMCP) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273 A1, WO 2021/009189 A1, WO 2021/009190 A1, WO 2021/009191 A1 and WO 2021/009192 A1. Full details of how to prepare suitable metallocene-catalysed multimodal copolymer (MMCP) can be found in these references.

The metallocene-catalysed multimodal copolymer (MMCP) is produced by using a metallocene catalyst. The metallocene catalyst preferably comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

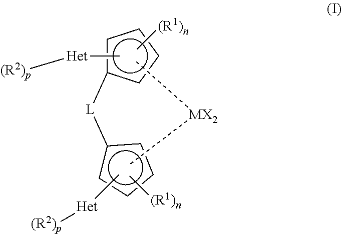

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl group or phenyl group optionally substituted by 1 to 3 C₁₋₆-alkyl groups; and
each p is 0 to 1.

Preferably, the compound of formula (I) has the structure

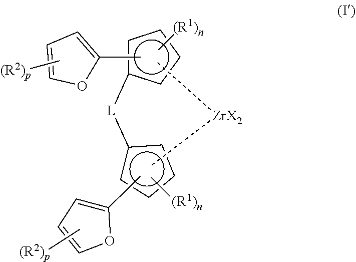

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl group or phenyl group.

Highly preferred complexes of formula (I) are

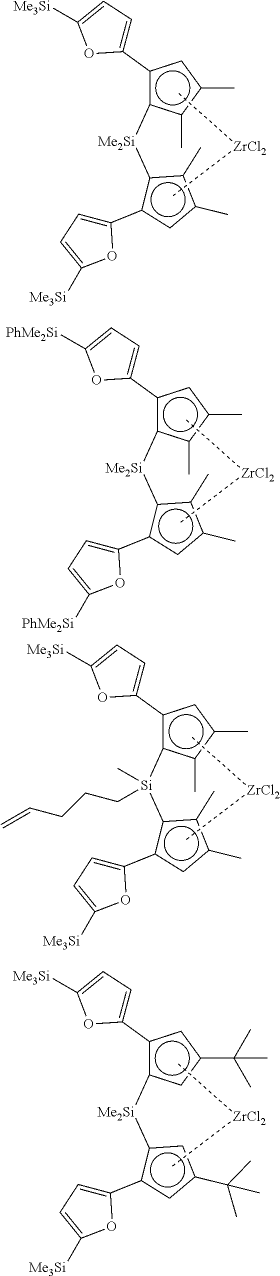

Most preferably the complex dimethylsilanediylbis[2-(5-trimethylsilylfuran-2-yl)-4,5-dimethylcyclopentadien-1-yl] zirconium dichloride is used.

More preferably the ethylene polymer components (A) and (B) of the multimodal copolymer (MMCP) are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

### Multilayered Film

A preferred embodiment of the multilayered film in accordance with the present invention stipulates that the skin layer (SKL) of the multilayered film has a thickness in the range of 1 to 100 μm; preferably in the range of 5 to 80 μm and more preferably in the range of 10 to 15 μm.

According to another preferred embodiment in accordance with the present invention the core layer (CL) of the multilayered film has a thickness in the range of 10 to 200 μm; preferably in the range of 20 to 80 μm and more preferably in the range of 30 to 45 μm.

In still another preferred embodiment according to the present invention the sealing layer (SL) of the multilayered film has a thickness in the range of 1 to 50 μm; preferably in the range of 5 to 25 μm and more preferably in the range of 10 to 15 μm.

In a further preferred embodiment according to the present invention the multilayered film has a thickness in the range of 12 to 350 μm; preferably in the range of 40 to 150 μm and more preferably in the range of 50 to 70 μm.

According to another preferred embodiment in accordance with the present invention the multilayer film consists of the skin layer (SKL), the core layer (CL) and the sealing layer (SL). It is self-explanatory that the core layer (CL) is placed between the skin layer (SKL) and the sealing layer (SL).

The core layer (CL) comprises at least the metallocene-catalysed multimodal polyethylene copolymer (MMCP) and a mixed-plastic-polyethylene recycling blend having a MFR2 (190° C., 2.16 kg, ISO 1133) in the range of 0.1 to 1.2 g/10 min and a density (ASTM D792) of 910 to 945 kg/m³.

In a preferred embodiment the core layer (CL) comprises 10 to 35 wt.-%, preferably 15 to 30 wt.-% and more preferably 18 to 25 wt.-% based on the total weight of the core layer (CL) of the metallocene-catalysed multimodal polyethylene copolymer (MMCP), preferably having a density (ASTM D792) in the range of 912 to 925 kg/m³, more preferably of 913 to 918 kg/m³ and a MFR₂ (190° C., 2.16 kg, ISO 1133) in the range of 0.5 to 1.4 g/10 min and 50 to 90 wt.-%, preferably 55 to 85 wt.-% and more preferably 68 to 82 wt.-% based on the total weight of the core layer (CL) of a mixed-plastic-polyethylene recycling blend having a MFR₂ (190° C., 2.16 kg, ISO 1133) in the range of 0.1 to 1.2 g/10 min, preferably of 0.3 to 1.1 g/10 min and a density (ASTM D792) of 910 to 945 kg/m³, preferably of 915 to 930 kg/m³, most preferably of 920 to 927 kg/m³.

The core layer (CL) may further comprise 0 to 15 wt.-%, more preferably 0 to 12 wt.-% and still more preferably 8 to 12 wt.-% based on the total weight of the core layer (CL) of a Ziegler-Natta catalysed linear low density polyethylene being preferably a multimodal alpha-olefin terpolymer, preferably having a density (ASTM D792) in the range of 920 to 970 kg/m³ and more preferably of 935 to 950 kg/m³ and a MFR₅ (190° C., 2.16 kg, ISO 1133) in the range of 0.1 to 2.5 g/10 min and preferably of 1.0 to 1.8 g/10 min; and/or 0 to 15 wt.-%, more preferably 0 to 12 wt.-% and still more preferably 6 to 10 wt.-% based on the total weight of the core layer (CL) of a high density polyethylene, preferably being bimodal, having a density (ASTM D792) in the range of 950 to 975 kg/m³ and more preferably of 955 to 965 kg/m³ and a MFR₅ (190° C., 2.16 kg, ISO 1133) in the range of 0.1 to 1.5 g/10 min and preferably of 0.5 to 1.0 g/10 min.

The skin layer (SKL) preferably comprises 65 to 95 wt.-%, preferably 80 to 95 wt.-%, more preferably 82 to 93 wt.-% and still more preferably 88 to 92 wt.-% based on the total weight of the skin layer (SKL) of the metallocene-catalysed multimodal polyethylene copolymer (MMCP), preferably having a density (ASTM D792) in the range of 912 to 925 kg/m³, more preferably of 913 to 918 kg/m³ and a MFR₂ (190° C., 2.16 kg, ISO 1133) in the range of 0.5 to 1.4 g/10 min; and 5 to 35 wt.-%, preferably 5 to 20 wt.-%, more preferably 7 to 18 wt.-%, still more preferably 8 to 12 wt.-% based on the total weight of the skin layer (SKL) of a LDPE having a density (ASTM D792) in the range of 910 to 930 kg/m³, preferably of 920 to 925 kg/m³ and a MFR₂ (190° C., 2.16 kg, ISO 1133) in the range of 0.5 to 4 g/10 min and preferably of 0.7 to 2 g/10 min.

The sealing layer (SL) preferably comprises 0 to 90 wt.-% or 50 to 90 wt.-%, preferably 70 to 85 wt.-% based on the total weight of the sealing layer (SL) of the metallocene-catalysed multimodal polyethylene copolymer (MMCP), preferably having a density (ASTM D792) in the range of 912 to 925 kg/m³, more preferably of 913 to 918 kg/m³ and a MFR₂ (190° C., 2.16 kg, ISO 1133) in the range of 0.5 to 1.4 g/10 min, and 0 to 80 wt.-% or 10 to 70 wt.-%, preferably 15 to 25 wt.-% based on the total weight of the sealing layer (SL) of a plastomer, being preferably a copolymer of ethylene and 1-octene, preferably having a density (ASTM D792) in the range of 860 to 910 kg/m³, preferably of 895 to 905 kg/m³ and a MFR₂ (190° C., 2.16 kg, ISO 1133) in the range of 0.5 to 10 g/10 min, preferably of 1.0 to 1.5 g/10 min; and 0 to 50 wt.-%, preferably 35 to 45 wt.-% based on the total weight of the sealing layer (SL) of a multimodal metallocene catalysed linear low density polyethylene being preferably a bimodal ethylene/1-butene/1-hexene terpolymer, preferably having a density (ASTM D792) in the range of 910 to 930 kg/m³, more preferably of 916 to 925 kg/m³; and a MFR₂ (190° C., 2.16 kg, ISO 1133) in the range of 0.5 to 2 g/10 min.

Another preferred embodiment in accordance with the present invention stipulates that the skin layer (SKL), the core layer (CL) and the sealing layer (SL) comprise the metallocene-catalysed multimodal polyethylene copolymer (MMCP).

The polymers used in the multilayered film according to the present invention may contain additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in form of a so-called master batch, which comprises the respective additive(s) together with a carrier polymer. In such case the carrier polymer is not calculated to the polymer components of the metallocene-catalysed multimodal polyethylene copolymer (MMCP), but to the amount of the respective additive(s), based on the total amount of polymer composition (100 wt.-%).

According to still another preferred embodiment in accordance with the present invention the multilayered film has a Tensile Modulus in MD (ISO 527-3) in the range of 150 to 300 MPa, preferably in the range of 190 to 240 MPa, and/or a Tensile Modulus in TD (ISO 527-3) in the range of 150 to 400 MPa, preferably in the range of 200 to 300 MPa, and/or a Dart Drop Strength (ISO 7765-1) in the range of 230 to 800 g, preferably in the range of 350 to 600 g.

In a further preferred embodiment in accordance with the present invention the multilayered film has a Haze (ASTM D1003-00) in the range of 5 to 15%, preferably in the range of 8 to 13%, and/or a Sealing Initiation Temperature determined as described in the specification in the range of 60 to 70° C. or 78 to 85° C., preferably in the range of 63 to 68° C. or 79 to 81° C., and/or a Hot Tack Force determined as described in the specification in the range of 6.0 to 8.0 N or 5.2 to 5.8 N, preferably in the range of 6.2 to 7.5 N or 5.4 to 5.6 N, and/or a Hot Tack Temperature determined as described in the specification in the range of 60 to 90° C., preferably in the range of 63 to 86° C.

Still a further preferred embodiment in accordance with the present invention stipulates that the multilayered film consists of polyethylene-based polymers.

### Method

Another aspect of the present invention relates to a method for producing the multilayered film.

The multilayered film according to the present invention is generally prepared by a conventional process, wherein the layers of the film are co-extruded.

The different polymer components in any of the layers of the film are typically intimately mixed prior to layer formation, for example using a twin screw extruder, preferably a counter-rotating extruder or a co-rotating extruder. Then, the blends are converted into a coextruded film. Generally, the multilayered film according to the present invention can be produced by a blown film or cast film process, preferably by a blown film process.

In order to manufacture such films, for example at least three polymer melt streams are simultaneously extruded (i.e. coextruded) through a multi-channel tubular, annular or circular die to form a tube which is blown-up, inflated and/or cooled with air (or a combination of gases) to form a film. The manufacture of blown film is a well-known process.

The blown (co-)extrusion can be effected at a temperature in the range 150 to 230° C., more preferably 160 to 225° C. and cooled by blowing gas (generally air) at a temperature of 10 to 40° C., more preferably 12 to 16° C. to provide a frost line height of 0.5 to 4 times, more preferably 1 to 2 times the diameter of the die.

The blow up ratio (BUR) should generally be in the range of 1.5 to 3.5, preferably 2.0 to 3.0, more preferably 2.1 to 2.8.

### Use

A further aspect of the present invention refers to the use of the multilayered film as packaging material, preferably for food and/or medical products.

The invention will now be described with reference to the following non-limiting examples.

### Experimental Part

### A. Measuring Methods

The following definitions of terms and determination methods apply for the above general description of the invention as well as to the below examples unless otherwise defined.

### Melt Flow Rate

The melt flow rate (MFR) was determined according to ISO 1133—Determination of the melt mass-flow rate (MFR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR of polyethylene is determined at a temperature of 190° C. and may be determined at different loadings such as 2.16 kg (MFR₂), 5 kg (MFR₅) or 21.6 kg (MFR₂₁).

### Calculation of MFR₂ of Component B and of Fraction (A-2)

$$log A = x \cdot log B + ( 1 - x ) \cdot log C \\ C = 10 {\hat{}}^{\frac{( log A - x \cdot log B )}{( 1 - x )}}$$

For Component B:
B=MFR₂ of Component (A)
C=MFR₂ of Component (B)
A=final MFR₂ (mixture) of multimodal polyethylene copolymer (P)
X=weight fraction of Component (A)

For Fraction (A-2):
B=MFR₂ of 1st fraction (A-1)
C=MFR₂ of 2nd fraction (A-2)
A=final MFR₂ (mixture) of loop polymer (=Component (A))
X=weight fraction of the 1st fraction (A-1)

### Density

Density of the polymer was measured according to ASTM; D792, Method B (density by balance at 23° C.) on compression moulded specimen prepared according to EN ISO 1872-2 and is given in kg/m³.

### DSC Analysis, Melting (Tm) and Crystallization Temperature (Tc)

Data may be measured with a TA Instrument Q2000 differential scanning calorimetry (DSC) on 5 to 7 mg samples. DSC was run according to ISO 11357/part 3/method C2 in a heat/cool/heat cycle with a scan rate of 10° C./min in the temperature range of −30 to +225° C. Crystallization temperature (T_{c}) and crystallization enthalpy (H_{c}) were determined from the cooling step, while melting temperature (Tₘ) and melting enthalpy (Hₘ) are determined from the second heating step.

### Dart Drop Strength (DDI): Impact Resistance by Free-Falling Dart Method

The DDI was measured according to ISO 7765-1:1988/Method A from the films as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Results:

Impact failure weight—50% [g]

### Tensile Modulus (TM)

Tensile modulus (MPa) was measured in machine (MD) and transverse direction (TD) according to ISO 527-3 on film samples prepared as described below at a cross head speed of 1 mm/min.

### Haze

The haze was determined according to ASTM D1003-00 on films as produced indicated below.

### Sealing Initiation Temperature (SIT); Sealing End Temperature (SET), Sealing Range

The method determines the sealing temperature range (sealing range) of polyethylene films, in particular blown films or cast films. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, delay time and grip separation rate have been modified. The determination of the force/temperature curve was continued until thermal failure of the film. The sealing range was determined on a J&B Universal Sealing Machine Type 4000 from the films as produced indicated below with the following further parameters:
Conditioning time: >96 h
Specimen width: 25 mm
Sealing pressure: 0.4 N/mm² (PE)
Sealing time: 1 sec
Delay time: 30 sec
Sealing jaws dimension: 50×5 mm
Sealing jaws shape: flat
Sealing jaws coating: Niptef
Sealing temperature: ambient −240° C.
Sealing temperature interval: 5° C.
Start temperature: 50° C.
Grip separation rate: 42 mm/sec

### Hot Tack Temperature (HTT) and Hot Tack Force (HTF)

HTT (lowest temperature to get maximum Hot Tack Force) and HTF (maximum Hot Tack Force) were measured according to ASTM F 1921 method B on films as produced indicated below a three-layer blown film of 60 μm thickness with below settings:
Q-name instrument: Hot Tack—Sealing Tester
Model: J&B model 4000 MB
Seal bar length: 50 [mm]
Seal bar width: 5 [mm]
Seal bar shape: flat
Seal Pressure: 0.15 N/mm²
Seal Time: 1 s
Coating of sealing bars: NIPTEF®
Roughness of coating sealing bars 1 [μm]
Film Specimen width: 25 mm
Cool time: 0.2 s
Peel Speed: 200 mm/s
Start temperature: 50° C.
End temperature: burn through and/or shrinking
Increments: 5° C.

All film test specimens were prepared in standard atmospheres for conditioning and testing at 23° C. (±2° C.) and 50% (±10%) relative humidity. The minimum conditioning time of test specimen in standard atmosphere just before start testing is at least 40 hours. The minimum storage time between extrusion of film sample and start testing is at least 88 hours. The hot-tack measurement determines the strength of heat seals formed in the films, immediately after the seal has been made and before it cools to ambient temperature.

HTF was measured as a function of temperature within the temperature range and with temperature increments as indicated above. The number of test specimens were at least 3 specimens per temperature. HTF is evaluated as the highest force (maximum peak value) with failure mode “peel”.

### Gel Content

The gel content was measured with a gel counting apparatus consisting of a measuring extruder, ME 25/5200 V1, 25*25D, with five temperature conditioning zones adjusted to a temperature profile of 170/180/190/190/190° C.), an adapter and a slit die (with an opening of 0.5*150 mm). Attached to this were a chill roll unit (with a diameter of 13 cm with a temperature set of 50° C.), a line camera (CCD 4096 pixel for dynamic digital processing of grey tone images) and a winding unit. For the gel count content measurements the materials were extruded at a screw speed of 30 rounds per minute, a drawing speed of 3-3.5 m/min and a chill roll temperature of 50° C. to make thin cast films with a thickness of 70 μm and a width of approximately 110 mm.

The resolution of the camera is 25 μm×25 μm on the film. The camera works in transmission mode with a constant grey value (auto.set. margin level=170). The system is able to decide between 256 grey values from black=0 to white=256. For detecting gels, a sensitivity level dark of 25% is used.

For each material the average number of gel dots on a film surface area of 10 m² was inspected by the line camera. The line camera was set to differentiate the gel dot size according to the following:
Gel size (the size of the longest dimension of a gel)
300 μm to 599 μm
600 μm to 999 μm
above 1000 μm.

### Dynamic Shear Measurements (Frequency Sweep Measurements)

The characterization of melt of polymer composition or polymer as given above or below in the context by dynamic shear measurements complies with ISO standards 6721-1 and 6721-10 and was conducted as described in WO 2021/105299 A1 pages 15 to 17.

### Strain Hardening (SH) Modulus

The strain hardening modulus has been determined as described in WO 2021/233818 A1, pages 36 to 38.

### Comonomer Contents—Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra were recorded in the molten-state using a Bruker Avance III 500 NMR spectrometer operating at 500.13 and 125.76 MHz for ¹H and ¹³C respectively. All spectra were recorded using a ¹³C optimized 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed utilizing the NOE at short recycle delays of 3 s {pollard04, klimke06} and the RS-HEPT decoupling scheme {fillip05,griffin07}. A total of 1024 (1 k) transients were acquired per spectra. Quantitative ¹³C{¹H} NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (δ+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( 3 * B + 2 * H ) / 2$$

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

$$fBtotal = Btotal / ( Etotal + Btotal + Htotal )$$

The amount isolated 1-butene incorporated in EEBEE sequences was quantified using the integral of the _{*}B2 sites at 39.8 ppm accounting for the number of reporting sites per comonomer:

$$B = {I}_{* B 2}$$

If present the amount consecutively incorporated 1-butene in EEBBEE sequences was quantified using the integral of the ααB2B2 site at 39.4 ppm accounting for the number of reporting sites per comonomer:

$$BB = 2 * I αα B 2 B 2$$

If present the amount non-of reporting sites per comonomer:

$$HEH = 2 * I ββ B 4 B 4$$

Sequences of HHH were not observed. The total 1-hexene content was calculated based on the sum of isolated, consecutive and non consecutively incorporated 1-hexene:

$$Htotal = H + H H + H EH$$

The total mole fraction of 1-hexene in the polymer was then calculated as:

$$fH = Htotal / ( Etotal + Btotal + Htotal )$$

The mole percent comonomer incorporation is calculated from the mole fraction:

$$B [ mol - \% ] = 100 * fB \\ H [ mol - \% ] = 100 * fH$$

The weight percent comonomer incorporation is calculated from the mole fraction:

$$B [ wt . - \% ] = 100 * ( fB * 56.11 ) / ( ( fB * 56.11 ) + ( fH * 84.16 ) + ( ( 1 - ( fB + fH ) ) * 28. 05 ) ) \\ H [ wt . - \% ] = 100 * ( fH * 84.16 ) / ( ( fB * 56.11 ) + ( fH * 84.16 ) + ( ( 1 - ( fB + fH ) ) * 28. 05 ) )$$

### REFERENCES

Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess, H. W., Wilhelm, M., Macromol. Chem. Phys. 2007; 208:2128.
Pollard, M., Klimke, K., Graf, R., Spiess, H. W., Wilhelm, M., Sperber, O., Piel, C., Kaminsky, W., Macromolecules 2004; 37:813.
Filip, X., Tripon, C., Filip, C., J. Mag. Resn. 2005, 176, 239.
Griffin, J. M., Tripon, C., Samoson, A., Filip, C., and Brown, S. P., Mag. Res. in Chem. 2007 45, S1, S198.
Castignolles, P., Graf, R., Parkinson, M., Wilhelm, M., Gaborieau, M., Polymer 50 (2009) 2373.
Busico, V., Cipullo, R., Prog. Polym. Sci. 26 (2001) 443.
Busico, V., Cipullo, R., Monaco, G., Vacatello, M., Segre, A. L., Macromolecules 30 (1997) 6251.
Zhou, Z., Kuemmerle, R., Qiu, X., Redwine, D., Cong, R., Taha, A., Baugh, D. Winniford, B., J. Mag. Reson. 187 (2007) 225.
Busico, V., Carbonniere, P., Cipullo, R., Pellecchia, R., Severn, J., Talarico, G., Macromol. Rapid Commun. 2007, 28, 1128.
Resconi, L., Cavallo, L., Fait, A., Piemontesi, F., Chem. Rev. 2000, 100, 1253.

### Molecular Weights, Molecular Weight Distribution, Mn, Mw, MWD

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain) or differential refractometer (RI) from Agilent Technologies, equipped with 3× Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g , {α}_{PS} = 0 \text{.655} \\ {K}_{PE} = 39 \times {10}^{- 3} mL / g , {α}_{PE} = 0.725$$

A third order polynomial fit was used to fit the calibration data.

All samples were prepared in the concentration range of 0.5-1 mg/ml and dissolved at 160° C. for 3 hours for PE under continuous gentle shaking.

### Determination of the Chemical Heterogeneity by Cross Fractionation Chromatography (CFC)

The chemical composition distribution as well as the determination of the molecular weight distribution and the corresponded molecular weight averages (Mn, Mw and Mv) at a certain elution temperature (polymer crystallinity in solution) were determined by a full automated Cross Fractionation Chromatography (CFC) as described by Ortin A., Monrabal B., Sancho-Tello J., Macromol. Symp., 2007, 257, 13-28 and WO 2018/210893 A1 on pages 18 and 19.

### Soluble Fraction SF@35° C.

The soluble fraction@35° C. is the polymer fraction eluting at 35° C.

### Mw(Tp(LCF, Mw(Tp(HCF), Half Peak Breadth Tp(LCF), Half Peak Breadth Tp(HCF)

To determine the weight average molecular weight at the peak maximum of the low crystalline fraction (Mw(Tp(LCF)), or of the high crystalline fraction (Mw(Tp(HCF)) and of the half peak breadth of Tp(LCF) and Tp(HCF) in a first step an a-TREF curve is retrieved from the CFC analysis, described above.

From the a-TREF curve the peak maximum of the high crystalline fraction (HCF) peak (Tp(HCF)) and of the low crystalline fraction (LCF) peak (Tp(LCF) are determined. The elution temperature of the Tp(HCF) is higher than Tp(LCF) and smaller than 99° C. Normally the high crystalline fraction is ranging from 90° C. to 99° C. and the low crystalline fraction is the polymer fraction eluting from 35 to 90° C. In FIG. 1 of WO 2018/210893 the a-TREF obtained from CFC analysis of IE1 and CE1 are shown.

The half peak breadth of both HCF and LCF are defined as the elution temperature difference between the front temperature and the rear temperature at the half of the maximum peak height of Tp(LCF) or Tp(HCF) respectively. The correspondent front temperature was searched forward from 35° C., while the rear temperature at the half of the maximum was searched backwards from 100° C., if the peaks are not well separated. If the LCF is well separated from HCF then the rear temperature was searched after the HCF.

In the next step the Mw at the elution temperature of Tp(LCF) and Tp(HCF) were determined. Therefore the Mw at the Tp(LCF) (Mw(Tp(LCF)) was calculated by a linear interpolation between the measured Mw values by GPC of the elution temperatures which was above the Tp(LCF) and below Tp(LCF). This was achieved by using e.g. “TREND” function in Excel. The same procedure was done to determine the Mw at Tp(HCF).

From the determined Mw(Tp(LCF), Mw(Tp(HCF), the half peak breadth (LCF) and half peak breadth (HCF) and the Tp(LCF) the following parameters can be calculated straight forward:

Mw(Tp(LCF)/Mw(Tp(HCF)

Delta Mw(TP(LCF))−Mw(TP(HCF) (g/mol)=Mw(TP(LCF)−Mw(TP(HCF) [g/mol]

Half peak breadth (LCF)/(98° C.−Tp(LCF)).

### B. Materials Used

FB5600 is a bimodal high density polyethylene (MFR₂ (190° C./2.16 kg): 0.70 g/10 min, density: 960 kg/m³, Tₘ 132° C.) commercially available as Borstar® FB5600 from Borouge.

FT5236 is a low density polyethylene (MFR₂ (190° C./2.16 kg): 0.75 g/10 min, density: 923 kg/m³, Tₘ 112° C., produced by Tubular Technology) commercially available as FT5236 from Borealis AG and contains anti-block, antioxidant and slip additives.

FK1820 is a bimodal ethylene/1-butene/1-hexene terpolymer (MFR₂ (190° C./2.16 kg): 1.5 g/10 min, density: 918 kg/m³, Tₘ 122° C., produced with a metallocene catalyst) commercially available as Anteo™ FK1820 from Borouge and contains antioxidant and processing aid.

Queo0201 is an unimodal ethylene based 1-octene plastomer (MFR₂ (190° C./2.16 kg): 1.1 g/10 min, density: 902 kg/m³, Tₘ 97° C., produced in a solution polymerization process using a metallocene catalyst) commercially available as Queo™ 0201 from Borealis AG and contains processing stabilizers.

NAV 101 is a low density polyethylene (LDPE) post-consumer recyclate blend commercially available from Ecoplast Kunststoffrecycling GmbH. The properties of NAV101 are shown in Table 1.

TABLE 1
Properties of NAV 101.

| | | |
|---|---|---|
| Ethylene content) | wt.-% | 90.67 |
| isolated C3 content | wt.-% | 0 |
| C4 content | wt.-% | 2.23 |
| C6 content | wt.-% | 2.73 |
| C7 content | wt.-% | 0.48 |
| iPP content | wt.-% | 3.89 |
| LDPE content | wt.-% | 33.00 |
| Density | kg/m³ | 923.9 |
| MFR₂ | g/10 min | 1.02 |
| MFR₅ | g/10 min | 3.57 |
| MFR₂₁ | g/10 min | 41.56 |
| SHI2.7/210 | | 22.16 |
| eta0.05 | Pa · s | 16187 |
| eta300 | Pa · s | 618 |
| PI | s⁻¹ | 1.46 |
| SH modulus | MPa | 14.3 |
| Gel content (>1000 μm) | 1/m² | 16.9 |
| Gel content (600-1000 μm) | 1/m² | 175.1 |
| Gel content (300-599 (μm) | 1/m² | 885.9 |
| Tc | ° C. | 109 |
| Tm1 | ° C. | 122 |
| Tm2 | ° C. | 109 |
| Hm1 | J/g | 125 |
| Hm2 | J/g | 290 |

ZNCP is a multimodal alpha-olefin terpolymer (MFR₅ (190° C./5 kg): 1.5 g/10 min, density: 941 kg/m³, Tₘ 128° C., produced with a Ziegler-Natta catalyst) and was produced as follows.

The polymerization was carried out in a Borstar pilot plant with a 3-reactor set-up (loop 1-loop 2-GPR) and a prepolymerization loop reactor according to the conditions as given in Table 2. A solid polymerization catalyst component produced as described in Example 1 of EP 1 378 528 A1 was introduced into the reactor together with triethylaluminium cocatalyst so that the molar ratio of Al/Ti was about 15.

TABLE 2
Polymerization conditions.

| Prepoly. reactor | |
|---|---|
| Temperature (° C.) | 70 |
| Pressure (kPa) | 5783 |
| Split (wt.-%) | 2 |
| First loop reactor | |
| Temperature (° C.) | 95 |
| Pressure (kPa) | 5512 |
| C2 (mol-%) | 4.7 |
| H2/C2 (mol/kmol) | 306 |
| MFR2 (g/10 min) | 195 |
| Split (wt.-%) | 18 |
| Second loop reactor | |
| Temperature (° C.) | 95 |
| Pressure (kPa) | 5382 |
| C2 (mol-%) | 5.5 |
| H2/C2 (mol/kmol) | 563 |
| Split (wt.-%) | 26 |
| MFR₂ (g/10 min) | 390 |
| Gas phase reactor | |
| Temperature (° C.) | 82 |
| Pressure (kPa) | 1988 |
| C2 (mol-%) | 13.1 |
| H2/C2 (mol/kmol) | 22.0 |
| C4/C2 (mol/kmol) | 94.4 |
| C6/C2 (mol/kmol) | 123.5 |
| Split (wt.-%) | 54 |

The polymer powder was mixed under nitrogen atmosphere with 1200 ppm of Irganox B561 (commercially available from BASF SE) and 400 ppm Ca-stearate. Then it was compounded and extruded under nitrogen atmosphere to pellets by using a JSW CIMP90 twin screw extruder.

MMCP1, MMCP2 and MMCP3 are multimodal copolymers and were prepared as follows:

### Catalyst Preparation (CAT)

### Loading of SiO2:

10 kg of silica (PQ Corporation ES757, calcined 600° C.) was added from a feeding drum and inertized in a reactor until O₂ level below 2 ppm was reached.

### Preparation of MAO/tol/MC:

30 wt.-% MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 minutes. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring was turned to 40 rpm during MAO/tol/MC addition. MAO/tol/MC solution (22.2 kg) was added within 205 minutes followed by 60 minutes stirring time (oil circulation temp was set to 25° C.). After stirring “dry mixture” was stabilised for 12 hours at 25° C. (oil circulation temp), stirring 0 rpm. Reactor was turned 20° (back and forth) and stirring was turned on 5 rpm for few rounds once an hour. After stabilisation the catalyst was dried at 60° C. (oil circulation temp) for 2 hours under nitrogen flow 2 kg/h, followed by 13 hours under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Polymerization:

The polymerization was carried out in a Borstar pilot plant with a 3-reactor set-up (loop 1-loop 2-GPR) and a prepolymerization loop reactor according to the conditions as given in Table 3.

TABLE 3
Polymerization conditions.

| | MMCP1 | MMCP2 | MMCP3 |
|---|---|---|---|
| Prepoly reactor | | | |
| Catalyst | CAT | CAT | CAT |
| Catalyst feed (g/h) | 35 | 27.4 | 29.9 |
| Temperature (° C.) | 50 | 50 | 50 |
| Pressure (kPa) | 5639 | 5636 | 5614 |
| C2 (kg/h) | 4.0 | 4.0 | 4.0 |
| H2 (g/h) | 0.04 | 0.03 | 0.03 |
| C4 (g/h) | 81.9 | 91.2 | 93.1 |
| Split (wt.-%) | 3.4 | 3.6 | 3.6 |
| loop 1 Fraction (A-1) | | | |
| Temperature (° C.) | 85 | 85 | 85 |
| Pressure (kPa) | 5544 | 5542 | 5536 |
| C2 conc. (mol-%) | 3.5 | 4.4 | 4.3 |
| H2/C2 ratio (mol/kmol) | 0.41 | 0.46 | 1.34 |
| C4/C2 ratio (mol/kmol) | 41 | 43.5 | 88.0 |
| Split (wt.-%) | 17.6 | 18.2 | 18.2 |
| Density (kg/m³) of loop 1 | 941 | 941.4 | 938.3 |
| material (fraction (A-1)) | | | |
| MFR₂ (g/10 min) of loop 1 | 5.0 | 6.9 | 120.0 |
| material (fraction (A-1)) | | | |
| loop 2 Fraction (A-2) | | | |
| Temperature (° C.) | 85 | 85 | 85 |
| Pressure (kPa) | 5325 | 5345 | 5350 |
| C2 conc. (mol-%) | 3.5 | 3.8 | 4.3 |
| H2/C2 ratio (mol/kmol) | 0.6 | 0.39 | 0.85 |
| C4/C2 ratio (mol/kmol) | 29 | 32.9 | 62.1 |
| Split (wt.-%) | 20.4 | 20.1 | 20.2 |
| Density (kg/m³) after loop 2 | 940.7 | 940.3 | 941.3 |
| (component (A)) | | | |
| MFR₂ (g/10 min) after loop 2 | 5.8 | 7.3 | 122 |
| (component (A)) | | | |
| MFR₂ (g/10 min) of loop 2 | 6.8 | 7.8 | 124.2 |
| material (fraction (A-2)) | | | |
| Density (kg/m³) of loop 2 | 941 | 939.1 | 944.5 |
| material (fraction (A-2)) | | | |
| C4 (mol-%) after loop 2 material | 0.72 | 0.96 | 1.43 |
| (Component (A)) | | | |
| GPR - component (B) | | | |
| Temperature (° C.) | 75.0 | 75 | 75 |
| Pressure (kPa) | 2000.0 | 2000 | 2000 |
| H2/C2 ratio (mol/kmol) | 1.18 | 0.75 | 0.77 |
| C6/C2 ratio (mol/kmol) | 14.5 | 9.58 | 10.06 |
| Split (wt.-%) | 58.6 | 58.2 | 58.1 |
| MFR₂ (g/10 min) of GPR | 0.5 | 0.09 | 0.01 |
| material (Component (B)) | | | |
| Density (kg/m³) of GPR | 891 | 904.4 | 898.0 |
| material (Component (B)) | | | |
| C6 (mol-%) of GPR material | 6.66 | 4.30 | 4.99 |
| (Component (B)) | | | |

The polymers (MMCP1-3) were mixed with 2400 ppm of Irganox B561 (commercially available from BASF) and 270 ppm of Dynamar FX 5922 (commercially available from 3M), compounded and extruded under nitrogen atmosphere to pellets by using a JSW extruder so that the SEI was 230 kWh/kg and the melt temperature 250° C. Table 4 summarizes some properties of MMCP1-3 and FK1820.

TABLE 4
Properties of multimodal copolymers.

| Properties | Unit | MMCP1 | MMCP2 | MMCP3 | FK1820 |
|---|---|---|---|---|---|
| MFR₂ | g/10 min | 1.3 | 0.58 | 0.63 | 1.5 |
| MFR₂₁ | g/10 min | 38.7 | 18.9 | 28.5 | 27.3 |
| MFR₂₁/MFR₂ | — | 29.8 | 32.6 | 43.8 | 18.2 |
| Density | kg/m³ | 913.0 | 919.4 | 916.2 | 918.0 |
| C4 | mol-% | 0.3 | 0.4 | 0.6 | 0.3 |
| C6 | mol-% | 3.9 | 2.5 | 2.9 | 2.9 |
| Tp(LCF) | ° C. | 48 | 57 | 54.5 | 60.5 |
| Half peak breadth (LCF) | ° C. | 26.7 | 11.4 | 12.7 | 24.7 |
| Mw(Tp(LCF)/Mw(Tp(HCF)* | | 1.10 | 2.57 | 4.96 | 1.74 |
| Delta Mw(TP(LCF)) − | g/mol | 6000 | 110000 | 136000 | 56000 |
| Mw(TP(HCF)* | | | | | |
| Half peak breadth (LCF)/ | | 0.53 | 0.28 | 0.29 | 0.66 |
| (98 − Tp(LCF)* | | | | | |
| SF@35° C./density_{P} | | 0.045 | 0.001 | 0.003 | 0.006 |
| SF@35° C. | wt.-% | 41.2 | 1.27 | 2.85 | 5.9 |

*HCF: High crystalline fraction/LCF: Low crystalline fraction. CFC data.

### C. Manufacturing of 3-Layered Films

3-layered films having the composition shown in Table 6 with a total thickness of 60 μm were produced on a Collin 3 layer lab line (BUR=1:2.5, take up speed=7 m/min, frost line 120 mm and melt temperature=210° C.).

### D. Results

TABLE 5
Composition and properties of 3-layered films.

| | | IE1 | IE2 | IE3 | IE4 | CE1 |
|---|---|---|---|---|---|---|
| Skin layer | FK1820 (wt.-%) | — | — | — | — | 18 |
| (12 μm) | MMCP2 (wt.-%) | 18 | 18 | — | — | — |
| | MMCP3 (wt.-%) | — | — | 18 | 18 | — |
| | FT5236 (wt.-%) | 2 | 2 | 2 | 2 | 2 |
| Core layer | ZNCP (wt.-%) | 6 | 6 | 6 | — | 6 |
| (36 μm) | FK1820 (wt.-%) | — | — | — | — | 12 |
| | NAV101 (wt.-%) | 42 | 42 | 42 | 42 | 42 |
| | MMCP2 (wt.-%) | 12 | 12 | — | — | — |
| | MMCP3 (wt.-%) | — | — | 12 | 14 | — |
| | FB5600 (wt.-%) | | | — | 4 | — |
| Sealing layer | MMCP1 (wt.-%) | — | 16 | 16 | 16 | — |
| (12 μm) | FK1820 (wt.-%) | 8 | — | — | — | 8 |
| | Queo0201 (wt.-%) | 12 | 4 | 4 | 4 | 12 |
| Properties | | | | | | |
| TM (MD) | MPa | 218 | 223 | 215 | 196 | 207 |
| TM (TD) | MPa | 278 | 268 | 250 | 216 | 235 |
| DDI | g | 593 | 383 | 539 | 551 | 383 |
| Haze | % | 8.3 | 11.4 | 11.4 | 10.3 | 7.6 |
| SIT | ° C. | 80 | 67 | 66 | 64 | 77 |
| HTF | N | 5.46 | 6.94 | 7.30 | 6.43 | 5.15 |
| HTT | ° C. | 85 | 85 | 65 | 70 | 85 |

### E. Discussion of the Results

As can be gathered from above Table 5 the films according to the present invention (IE1-4) show not only better mechanical properties (high dart drop impact strength and Tensile Modulus) as the film according to the Comparative Example (CE1), but also have superior sealing properties (see Sealing Initiation Temperature SIT, Hot Tack Temperature and Hot Tack Force).

1.-15. (canceled)

16. A multilayered film comprising:
a skin layer, a core layer and a sealing layer wherein:
at least the core layer includes a metallocene-catalysed multimodal polyethylene copolymer (MMCP) which includes:
(i) 35.0 to 50.0 wt.-% based on a total weight of MMCP of an ethylene-1-butene polymer component (A); and
(ii) 50.0 to 65.0 wt.-% based on the total weight of MMCP of an ethylene-1-hexene polymer component (B); wherein
the ethylene-1-butene polymer component (A) has
a density (ASTM D792) in a range of 920 to 960 kg/m³;
a MFR₂ (190° C., 2.16 kg, ISO 1133) in a range of 3.0 to 300.0 g/10 min;
a 1-butene content in a range of 0.1 to 3.0 mol-%, based on the ethylene-1-butene polymer component (A); and
the ethylene-1-hexene polymer component (B) has:
a density (ASTM D792) in a range of 880 to 920 kg/m³;
an MFR₂ (190° C., 2.16 kg, ISO 1133) in a range of 0.001 to 1.0 g/10 min;
a 1-hexene content in a range of 1.5 to 10.0 mol-% based on the ethylene-1-hexene polymer compound (B); and
the metallocene-catalysed multimodal polyethylene copolymer (MMCP) has:
a density (ASTM D792) in a range of 910 to 930 kg/m³;
a MFR₂ (190° C., 2.16 kg, ISO 1133) in a range of 0.1 to 1.4 g/10 min; and
a ratio of MFR₂₁ (190° C., 21.6 kg, ISO 1133) to MFR₂ (190° C., 2.16 kg, ISO 1133), MFR₂₁/MFR₂, in a range of 22 to 70;
whereby the core layer includes:
a mixed-plastic-polyethylene recycling blend having a MFR₂ (190° C., 2.16 kg, ISO 1133) in a range of 0.1 to 1.2 g/10 min and a density (ASTM D792) of 910 to 945 kg/m³.

17. The multilayered film according to claim 16, wherein the metallocene-catalysed multimodal polyethylene copolymer (MMCP) comprises:
a ratio of a soluble fraction at 35° C. determined with crossfractionation chromatography (CFC) as described in an experimental part to a density of the MMCP, SF@35° C./density_{MMCP} of below 0.007 or below 0.050, wherein an amount of the soluble fraction at 35° C. is in a range of 0.5 to 6.0 wt.-% or 39 to 43 wt.-%, based on the total weight of the MMCP; and/or
a ratio of the MFR₂₁ (190° C., 21.6 kg, ISO 1133) to MFR₂ (190° C., 2.16 kg, ISO 1133), MFR₂₁/MFR₂ in a range of 22 to 50, and/or of 28 to 46.

18. The multilayered film according to claim 16, wherein the skin layer (SKL) of the multilayered film comprises:
a thickness in a range of 1 to 100 μm; and/or in a range of 5 to 80 μm, and/or in a range of 10 to 15 μm; and/or
the core layer of the multilayered film has a thickness in a range of 10 to 200 μm, and/or in a range of 20 to 80 μm, and/or in a range of 30 to 45 μm; and/or
the sealing layer of the multilayered film has a thickness in a range of 1 to 50 μm, and/or in a range of 5 to 25 μm, and/or in a range of 10 to 15 μm, and/or
the multilayered film has a thickness in a range of 12 to 350 μm; and/or in a range of 40 to 150 μm, and/or in a range of 50 to 70 μm.

19. The multilayered film according to claim 16, wherein the multilayer film consists of the skin layer, the core layer and the sealing layer; and the skin layer comprises:
65 to 95 wt.-%, and/or 80 to 95 wt.-%, and/or 82 to 93 wt.-%, and/or 88 to 92 wt.-% based on a total weight of the skin layer of the metallocene-catalysed multimodal polyethylene copolymer, and/or having a density (ASTM D792) in a range of 912 to 925 kg/m³, and/or of 913 to 918 kg/m³, and a MFR₂ (190° C., 2.16 kg, ISO 1133) in a range of 0.5 to 1.4 g/10 min; and
5 to 35 wt.-%, and/or 5 to 20 wt.-%, and/or 7 to 18 wt.-%, and/or 8 to 12 wt.-% based on the total weight of the skin layer of a LDPE having a density (ASTM D792) in a range of 910 to 930 kg/m³, and/or of 920 to 925 kg/m³, and a MFR₂ (190° C., 2.16 kg, ISO 1133) in a range of 0.5 to 4 g/10 min, and/or of 0.7 to 2 g/10 min.

20. The multilayered film according to claim 16, wherein the multilayer film consists of the skin layer, the core layer and the sealing layer; and the core layer comprises:
10 to 35 wt.-%, and/or 15 to 30 wt.-%, and/or 18 to 25 wt.-% based on a total weight of the core layer of the metallocene-catalysed multimodal polyethylene copolymer, and/or having a density (ASTM D792) in a range of 912 to 925 kg/m³, and/or of 913 to 918 kg/m³ and a MFR₂ (190° C., 2.16 kg, ISO 1133) in a range of 0.5 to 1.4 g/10 min; and
50 to 90 wt.-%, and/or 55 to 85 wt.-%, and/or 68 to 82 wt.-% based on the total weight of the core layer of a mixed-plastic-polyethylene recycling blend having a MFR₂ (190° C., 2.16 kg, ISO 1133) in a range of 0.1 to 1.2 g/10 min, and/or of 0.3 to 1.1 g/10 min, and a density (ASTM D792) of 910 to 945 kg/m³, and/or of 915 to 930 kg/m³, and/or of 920 to 927 kg/m³; and
0 to 15 wt.-%, and/or 0 to 12 wt.-%, and/or 8 to 12 wt.-% based on the total weight of the core layer of a Ziegler-Natta catalysed linear low density polyethylene being a multimodal alpha-olefin terpolymer, and/or having a density (ASTM D792) in a range of 920 to 970 kg/m³, and/or of 935 to 950 kg/m³, and a MFR₅ (190° C., 2.16 kg, ISO 1133) in a range of 0.1 to 2.5 g/10 min, and/or of 1.0 to 1.8 g/10 min; and
0 to 15 wt.-%, and/or 0 to 12 wt.-%, and/or 6 to 10 wt.-% based on the total weight of the core layer of a high density polyethylene, and/or being bimodal, having a density (ASTM D792) in a range of 950 to 975 kg/m³, and/or of 955 to 965 kg/m³, and a MFR₂ (190° C., 2.16 kg, ISO 1133) in a range of 0.1 to 1.5 g/10 min, and/or of 0.5 to 1.0 g/10 min.

21. The multilayered film according to claim 16, wherein the multilayer film consists of the skin layer, the core layer and the sealing layer; and/or
the sealing layer comprises:
0 to 90 wt.-% or 50 to 90 wt.-%, and/or 70 to 85 wt.-% based on a total weight of the sealing layer of the metallocene-catalysed multimodal polyethylene copolymer, and/or having a density (ASTM D792) in a range of 912 to 925 kg/m³, and/or of 913 to 918 kg/m³, and a MFR₂ (190° C., 2.16 kg, ISO 1133) in a range of 0.5 to 1.4 g/10 min; and
0 to 80 wt.-% or 10 to 70 wt.-%, and/or 15 to 25 wt.-% based on the total weight of the sealing layer of a plastomer, being a copolymer of ethylene and 1-octene, and/or having a density (ASTM D792) in a range of 860 to 910 kg/m³, and/or of 895 to 905 kg/m³, and a MFR₂ (190° C., 2.16 kg, ISO 1133) in a range of 0.5 to 10 g/10 min, and/or of 1.0 to 1.5 g/10 min; and
0 to 50 wt.-%, and/or 35 to 45 wt.-% based on the total weight of the sealing layer of a multimodal metallocene catalysed linear low density polyethylene being a bimodal ethylene/1-butene/1-hexene terpolymer, having a density (ASTM D792) in a range of 910 to 930 kg/m³, and/or of 916 to 925 kg/m³; and a MFR₂ (190° C., 2.16 kg, ISO 1133) in a range of 0.5 to 2 g/10 min.

22. The multilayered film according to claim 16, wherein the skin layer, the core layer and the sealing layer comprise:
the metallocene-catalysed multimodal polyethylene copolymer.

23. The multilayered film according to claim 16, wherein the metallocene-catalysed multimodal polyethylene copolymer comprises:
a ratio of the molecular weight (M_{w}) of the low crystalline fraction (LCF) to a molecular weight (M_{w}) of the high crystalline fraction (HCF), M_{w}(Tp(LCF)/M_{w}(Tp(HCF), determined as described in the experimental part, in a range of >1.0 to 10.0; and/or
a ratio of a breadth at Half peak height (LCF)/(98−Tp(LCF)) in a range of of 0.10 to 1.50; and/or
a delta of Mw(LCF)−Mw(HCF) of at least 5000 up to 200000 g/mol.

24. The multilayered film according to claim 16, wherein component (A) of the metallocene-catalysed multimodal polyethylene copolymer consists of an ethylene polymer fraction (A-1) and an ethylene polymer fraction (A-2), wherein the ethylene polymer fraction (A-1) comprises:
a density (ASTM D792) in a range of 925 to 960 kg/m³, and/or of 925 to 955 kg/m³, and/or of 930 to 950 kg/m³; and/or
a MFR₂ (190° C., 2.16 kg, ISO 1133) in a range of 3.0 to 300.0 g/10 min, and/or of 3.0 to 10.0 g/10 min or 80 to 150, and/or of 4.0 to 7.0 g/10 min or 115 to 125 g/10 min; and/or
the ethylene polymer fraction (A-2) includes:
a density (ASTM D792) in a range of 925 to 960 kg/m³, and/or of 925 to 955 kg/m³, and/or of 930 to 950 kg/m³; and/or
a MFR₂ (190° C., 2.16 kg, ISO 1133) in a range of 3.0 to 300.0 g/10 min, and/or of 3.0 to 10.0 g/10 min or 80 to 150, and/or of 6.0 to 8.0 g/10 min or 115 to 125 g/10 min.

25. The multilayered film according to claim 16, wherein the metallocene-catalysed multimodal copolymer comprises:
a total amount of 1-butene, based on the multimodal polymer in the range of 0.1 to 1.0 mol-%, and/or of 0.2 to 0.8 mol-%, and/or of 0.3 to 0.7 mol-%; and/or
a total amount of 1-hexene, based on the multimodal polymer is in a range of 1.5 to 8.0 mol-%, and/or of 2.0 to 6.0 mol.-%, and/or of 2.2 to 4.0 mol-%; and/or
a content of the ethylene-1-butene polymer component (A) of 35 to 50 wt.-% based on the total weight of MMCP, and/or of 36 to 48 wt.-%, and/or of 38 to 45 wt.-%; and/or
a content of the ethylene-1-hexene polymer component (B) of 50 to 65 wt.-% based on the total weight of MMCP, and/or of 52 to 64 wt.-%, and/or of 55 to 62 wt.-%.

26. The multilayered film according to claim 16, wherein the metallocene-catalysed multimodal copolymer is configured from a presence of a metallocene complex of formula (I): 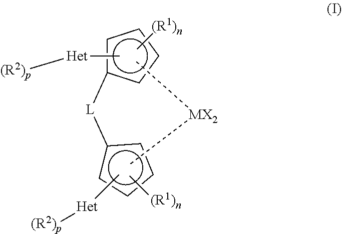
wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R₁ is a same or different and is a C₁₋₆-alkyl group or C₁₋₆-alkoxy group;
each n is 1 to 2;
each R₂ is a same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

27. The multilayered film according to claim 16, wherein said multilayered film comprises:
a Tensile Modulus in MD (ISO 527-3) in a range of 150 to 300 MPa, and/or in a range of 190 to 240 MPa; and/or
a Tensile Modulus in TD (ISO 527-3) in a range of 150 to 400 MPa, and/or in a range of 200 to 300 MPa; and/or
a Dart Drop Strength (ISO 7765-1) in a range of 230 to 800 g, and/or in a range of 350 to 600 g.

28. The multilayered film according to claim 16, wherein said multilayered film comprises:
a Haze (ASTM D1003-00) in the range of 5 to 15%, and/or in a range of 8 to 13%; and/or
a Sealing Initiation Temperature determined as described in a specification in a range of 60 to 70° C. or 78 to 85, and/or in a range of 63 to 68° C. or 79 to 81° C.; and/or
a Hot Tack Force determined as described in the specification in a range of 6.0 to 8.0 N or 5.2 to 5.8 N, and/or in a range of 6.2 to 7.5 N or 5.4 to 5.6 N; and/or
a Hot Tack Temperature determined as described in the specification in a range of 60 to 90° C., and/or in a range of 63 to 86° C.

29. The multilayered film according to claim 16, wherein said multilayered film consists of polyethylene-based polymers.

30. The multilayered film according to claim 16, configured as packaging material, for food and/or medical products.
